(19) United States
(12) Patent Application Publication
(10) Pub. No.: US 2024/0218103 A1
(43) Pub. Date: Jul. 4, 2024

(54) CURABLE COMPOSITION AND FILM PREPARED THEREFROM

(71) Applicant: ROHM AND HAAS ELECTRONIC MATERIALS KOREA LTD., Chungcheongnam-do (KR)

(72) Inventors: Ji-Ung KIM, Gyeonggi-do (KR); Geun HUH, Gyeonggi-do (KR); Hyung-Tak JEON, Gyeonggi-do (KR); Seung-Kyu SONG, Gyeonggi-do (KR)

(21) Appl. No.: 18/537,169

(22) Filed: Dec. 12, 2023

(30) Foreign Application Priority Data
Dec. 22, 2022 (KR) 10-2022-0182029

(51) Int. Cl. C08F 222/10; C08F 2/50; C08J 5/18; C08K 5/12; C08K 5/5397; C08K 5/544

(52) U.S. Cl. CPC C08F 222/1065; C08F 2/50; C08J 5/18; C08K 5/12; C08K 5/5397; C08K 5/544; C08J 2335/02

(57) ABSTRACT

The present invention relates to a curable composition and a film. Specifically, as the curable composition according to an embodiment of the present invention comprises a urethane (meth)acrylate oligomer derived from a polyol represented by Formula 1, it can provide a film having excellent scratch resistance and mechanical properties, as well as excellent flexibility and pliability to have a low glass transition temperature and a high storage modulus.

### TECHNICAL FIELD

The present invention relates to a curable composition and a film prepared therefrom. More specifically, the present invention relates to a curable composition that is capable of forming a film having a high storage modulus as compared with conventional films while having excellent impact resistance, scratch resistance, mechanical properties, flexibility, and pliability; and to a film that is prepared therefrom and can be used for a liquid crystal display device, an organic EL display device, and the like.

### BACKGROUND ART

Display technologies continue to develop driven by the demand in tandem with the development of IT devices. Thin display devices such as liquid crystal display devices or organic EL display (organic light emitting diode display) devices are implemented in the form of a touchscreen panel and widely used. In addition, technologies on curved displays and bent displays have already been commercialized. In recent years, flexible display devices capable of providing a large screen and portability at the same time by being flexibly bent or folded in response to an external force are favored.

Display devices based on portable touchscreen panels, such as smartphones or tablet PCs, have a window cover for protecting the display on one side of the display panel to protect the display panel from scratches or external impacts. In particular, flexible display devices mainly adopt a polymer film or tempered glass as a cover window. Polymer films such as polyethylene terephthalate (PET), polyethersulfone (PES), polyethylene naphthalate (PEN), polycarbonate (PC), and polyimide (PI) have limitations in enhancing mechanical properties as well as scratch resistance. Tempered glass is not suitable for light-weighting of portable devices due to its heavy weight and is not suitable for flexible display devices due to its low flexibility and pliability. In addition, since a cover window applied to a flexible display device is continuously subject to a tensile load in a folded state, the film at the folded part may not completely adhere to the cover window and may be lifted or cracked due to repeated folding if the flexibility or pliability is low.

Accordingly, research is ongoing on a film capable of effectively preventing lifting or cracking even when applied as a cover window of a flexible display device by virtue of its excellent impact resistance, scratch resistance, mechanical properties, as well as excellent flexibility and pliability, and a composition capable of forming such a film.

### PRIOR ART DOCUMENT

### Patent Document

(Patent Document 1) Japanese Laid-open Patent Publication No. 2017-149813

### DISCLOSURE OF INVENTION

### Technical Problem

Accordingly, an object of the present invention is to provide a curable composition capable of forming a film having excellent impact resistance, scratch resistance, and mechanical properties, as well as excellent flexibility and pliability to have a low glass transition temperature and a high storage modulus, and a film prepared therefrom.

### Solution to Problem

In order to accomplish the above object, the present invention provides a curable composition, which comprises (A) a urethane (meth)acrylate oligomer derived from a polyol represented by the following Formula 1; (B) a (meth)acrylate-based crosslinking agent; and (C) a photopolymerization initiator.

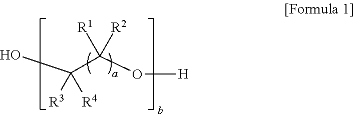

In Formula 1, R¹ to R⁴ are each independently hydrogen or a C₁₋₆ alkyl group, a is an integer of 1 to 10, and b is an integer of 5 to 90.

In order to accomplish another object, the present invention provides a curable composition, which comprises (A) a urethane (meth)acrylate oligomer derived from a polyol represented by the following Formula 1; (B) a (meth)acrylate-based crosslinking agent; and (C) a photopolymerization initiator, wherein a film prepared from the curable composition has a glass transition temperature (Tg) of −60° C. to −10° C. when measured using a dynamic mechanical analyzer (DMA).

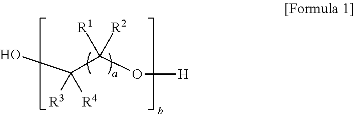

In Formula 1, R¹ to R⁴ are each independently hydrogen or a C₁₋₆ alkyl group, a is an integer of 1 to 10, and b is an integer of 5 to 90.

In order to accomplish another object, the present invention provides a film prepared from the curable composition.

### Advantageous Effects of Invention

As the curable composition of the present invention comprises a urethane (meth)acrylate oligomer derived from a polyol represented by Formula 1, it can provide a film having excellent scratch resistance and mechanical properties, as well as excellent flexibility and pliability to have a low glass transition temperature and a high storage modulus.

Further, as the curable composition comprises a urethane (meth)acrylate oligomer derived from a polyol represented by Formula 1, a (meth)acrylate-based crosslinking agent, and a photopolymerization initiator, while the content ratios of the constituent components are adjusted, it is possible to achieve an appropriate storage modulus and to secure a low yellow index and excellent stability over time.

### BRIEF DESCRIPTION OF DRAWINGS

FIG. 1 shows the glass transition temperature (Tg) of the films of Example 2-3 and Comparative Example 2-3 measured using a dynamic mechanical analyzer (DMA).

FIG. 2 is a photograph of the surface of the film in Example 2-3 subjected to repeated bending test 2.

FIG. 3 is a photograph of the surface of the film in Comparative Example 2-1 subjected to repeated bending test 2.

FIG. 4 is a photograph of the surface of the film in Comparative Example 2-3 subjected to repeated bending test 2.

### BEST MODE FOR CARRYING OUT THE INVENTION

Hereinafter, the present invention will be described in detail. The present invention is not limited to the disclosures given below, but it may be modified into various forms as long as the gist of the invention is not changed.

Throughout the present specification, when a part is referred to as “comprising” an element, it is understood that other elements may be comprised, rather than other elements are excluded, unless specifically stated otherwise.

All numbers and expressions related to the quantities of components, reaction conditions, and the like used herein are to be understood as being modified by the term “about,” unless otherwise indicated.

As used herein, the term “(meth)acrylate” refers to “acrylate” and/or “methacrylate.”

The weight average molecular weight (g/mole) of each component as described below is measured by gel permeation chromatography (GPC, eluent: tetrahydrofuran) referenced to a polystyrene standard.

### Curable Composition

The present invention provides a curable composition, which comprises (A) a urethane (meth)acrylate oligomer derived from a polyol represented by the following Formula 1; (B) a (meth)acrylate-based crosslinking agent; and (C) a photopolymerization initiator.

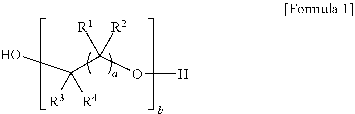

In Formula 1, R¹ to R⁴ are each independently hydrogen or a C₁₋₆ alkyl group, a is an integer of 1 to 10, and b is an integer of 5 to 90.

In addition, the present invention provides a curable composition, which comprises (A) a urethane (meth)acrylate oligomer derived from a polyol represented by the following Formula 1; (B) a (meth)acrylate-based crosslinking agent; and (C) a photopolymerization initiator, wherein a film prepared from the curable composition has a glass transition temperature (Tg) of −60° C. to −10° C. when measured using a dynamic mechanical analyzer (DMA).

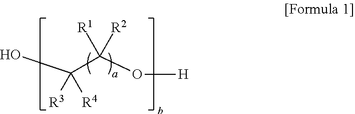

In Formula 1, R¹ to R⁴ are each independently hydrogen or a C₁₋₆ alkyl group, a is an integer of 1 to 10, and b is an integer of 5 to 90.

### (A) Urethane (Meth)Acrylate Oligomer

The urethane (meth)acrylate oligomer used in the present invention is derived from a polyol represented by Formula 1.

Specifically, the urethane (meth)acrylate oligomer may be derived from an acrylate-based compound, an isocyanate-based compound, and a polyol represented by the above Formula 1.

The acrylate-based compound may be selected from the group consisting of tricyclodecane dimethanol diacrylate, isobornyl acrylate, 2-norbornyl (meth)acrylate, dicyclopentenyl (meth)acrylate, tricyclodecyl (meth)acrylate, trimethylnorbornyl cyclohexyl (meth)acrylate, dihydrodicyclopentadienyl acrylate, 2-(2-ethoxyethoxy) ethyl acrylate, tripropylene glycol diacrylate, trimethylolpropane ethoxy triacrylate, ethylene glycol dicyclopentenyl ether (meth)acrylate, methylbicycloheptyl (meth)acrylate, ethyltricyclodecyl (meth)acrylate, adamantanyl (meth)acrylate, methyladamantanyl (meth)acrylate, ethyladamantanyl (meth)acrylate, hydroxymethyl adamantanyl (meth)acrylate, 3-hydroxy-1-adamantanyl (meth)acrylate, methoxybutyl adamantanyl (meth)acrylate, carboxyl adamantanyl (meth)acrylate, 5-oxo-4-oxatricyclo[4.2.1.03,7]nonan-2-ylprop-2-enoate, 7-oxabicyclo[4.1.0]heptane-3-ylmethylprop-2-enoate, tripropyleneglycol-diacrylate, neopentylglycol diacrylate, 3-methyl-1,5-pentanediol diacrylate, 1,6-hexanediol diacrylate, hydroxypivalaldehyde-modified trimethylolpropane diacrylate, tert-butyl methacrylate, cyclohexyl methacrylate, N,N-dimethylacrylamide, N-isopropylacrylamide, phenylacrylamide, t-butylacrylamide, N-methylacrylamide, N-hydroxyethylacrylamide, bisphenol A diacrylate, and combinations thereof.

In addition, the isocyanate-based compound may have an average of 2 or more isocyanate groups, preferably 2 to 4 isocyanate groups, per molecule. For example, the isocyanate-based compound may be an aliphatic, alicyclic, aryl-aliphatic, or aromatic isocyanate that contains 5 to 20 carbon atoms, and diisocyanate may be preferable, but it is not limited thereto.

In general, alicyclic or aliphatic isocyanates may be preferred to enhance impact resistance, flexibility, and pliability. However, as the present invention employs a polyol represented by Formula 1, impact resistance, flexibility, and pliability can be enhanced even if the type of isocyanate is not particularly limited, such as alicyclic or aliphatic isocyanate, as well as aryl-aliphatic or aromatic isocyanate.

For example, the isocyanate compound may comprise at least one isocyanate selected from the group consisting of 5-isocyanato-1-(isocyanatomethyl)-1,3,3-trimethylcyclohexane, bis(4-isocyanatocyclohexyl)methane, bis(isocyanatomethyl)cyclohexane, dicyclohexylmethane diisocyanate, 1,4-cyclohexane diisocyanate, 1,3-bis(isocyanatomethyl)cyclohexane, 2,5-bis(isocyanatomethyl)-bicyclo[2.2.1]heptane, 2,6-bis(isocyanatomethyl)-bicyclo[2.2.1]heptane, dicyclohexylmethane diisocyanate, 1,2-diisocyanatobenzene, 1,3-diisocyanatobenzene, 1,4-diisocyanatobenzene, 2,4-diisocyanatotoluene, hexamethylene diisocyanate, bis(isocyanatomethyl)cyclohexane, 2,2,4-trimethyl-hexamethylene diisocyanate, 2,4,4-trimethyl-hexamethylene diisocyanate, 2-methyl-1,5-pentamethylene diisocyanate, ethylphenylene diisocyanate, dimethylphenylene diisocyanate, toluidine diisocyanate, 4,4′-methylenebis(phenylisocyanate), 1,2-bis(isocyanatomethyl)benzene, 1,3-bis(isocyanatomethyl)benzene, 1,4-bis(isocyanatomethyl)benzene, 1,2-bis(isocyanatoethyl)benzene, 1,3-bis(isocyanatoethyl)benzene, 1,4-bis(isocyanatoethyl)benzene, bis(isocyanatomethyl)naphthalene, bis(isocyanatomethyl)sulfide, bis(isocyanatomethylphenyl)ether, bis(isocyanatoethyl)sulfide, 2,5-bis(isocyanatopropyl)sulfide, diisocyanatotetrahydrothiophene, 2,5-diisocyanatomethyltetrahydrothiophene, 3,4-diisocyanatomethyltetrahydrothiophene, 2,5-diisocyanato-1,4-dithiane, 2,5-diisocyanato-methyl-1,4-dithiane, xylylene diisocyanate, m-tetramethyl xylylene diisocyanate, p-tetramethyl xylylene diisocyanate, 1,4-xylylene diisocyanate, 1,3-xylylene diisocyanate, hydrogenated xylylene diisocyanate, norbornene diisocyanate, 4,4′-diphenylmethylene diisocyanate, toluene diisocyanate, and naphthalene diisocyanate.

The polyol represented by Formula 1 may have a weight average molecular weight of 4,400 g/mole to 16,000 g/mole. For example, the weight average molecular weight of the polyol represented by Formula 1 may be 4,400 g/mole to 16,000 g/mole, 6,000 g/mole to 12,000 g/mole, or 8,000 g/mole to 10,000 g/mole.

In addition, the urethane (meth)acrylate oligomer may be derived from 2% by weight to 10% by weight of the acrylate-based compound, 3% by weight to 20% by weight of the isocyanate-based compound, and 70% by weight to 95% by weight of the polyol represented by the above Formula 1.

For example, the urethane (meth)acrylate oligomer may be derived from 2% by weight to 9% by weight, 4% by weight to 8% by weight, or 5% by weight to 6% by weight of the acrylate-based compound, 3% by weight to 20% by weight, 5% by weight to 15% by weight, or 8% by weight to 11% by weight of the isocyanate-based compound, and 70% by weight to 95% by weight, 80% by weight to 92% by weight, or 85% by weight to 90% by weight of the polyol represented by the above Formula 1.

Examples of the commercially available urethane (meth)acrylate oligomer include SUO-2172, SUO-H7000, SUO-9103120, and SUO-3110H20 (Shin-A TNC products), Ebecryl™ 8465, Ebecryl™ 4513, Ebecryl™ 4740, Ebecryl™ 264, Ebecryl™ 265, Ebecryl™ 1258, Ebecryl™ 3703, Ebecryl™ 8800-20R, Ebecryl™ 8501, Ebecryl™ 230, Ebecryl™ 270, Ebecryl™ 8896, RX 20089, RX 20095, and RX 20097 (Allnex USA Inc. products), Photomer™ 6010 and Photomer™ 6892 (IGM Resins products), CN 929, CN 8804, CN 9021, and CN 8804 (Sartomer USA, LLC products), BR-742S, BR-742M, BR541 MB, BR344, Bomar™ BR-641D, Bomar™ BR-7432 GB, Bomar™ BR-344, Bomar™ BR-345, Bomar™ BR-374, Bomar™ BR-543, Bomar™ BR-3042, Bomar™ BR-3641AA, Bomar™ BR-3641AJ, Bomar™ BR-3741, Bomar™ BR-3741AJ, Bomar™ BR-14320S, Bomar™ BR-204, and Bomar™ BR-543 MB (Dymax Corporation products).

In addition, the curable composition may comprise the urethane (meth)acrylate oligomer in an amount of 50% by weight to 90% by weight based on solids content. For example, the curable composition may comprise the urethane (meth)acrylate oligomer in an amount of 51% by weight to 88% by weight, 52% by weight to 85% by weight, 53% by weight to 82% by weight, 54% by weight to 81% by weight, 50% by weight to 80% by weight, 52% by weight to 78% by weight, or 54% by weight to 76% by weight, based on solids content.

As the content of the urethane (meth)acrylate oligomer satisfies the above range, specifically, as the contents of the respective components of the curable composition are adjusted, it is possible to provide a film having excellent scratch resistance and mechanical properties, as well as excellent flexibility and pliability to have a low glass transition temperature and a high storage modulus. More specifically, as the present invention employs the polyol represented by Formula 1, it is possible to further enhance flexibility and pliability without deterioration in scratch resistance and mechanical properties.

### (B) (Meth)Acrylate-Based Crosslinking Agent

The curable composition of the present invention comprises a (meth)acrylate-based crosslinking agent.

Specifically, the curable composition may comprise at least one (meth)acrylate-based crosslinking agent having at least one reactive (meth)acrylate moiety. When the curable composition of the present invention is cured, the crosslinking agent may react with the other components of the composition to form a cured coating.

Specifically, the (meth)acrylate-based crosslinking agent may be a monofunctional acrylate crosslinking agent, a bifunctional acrylate crosslinking agent, or a trifunctional or higher functional acrylate crosslinking agent. For example, the (meth)acrylate-based crosslinking agent may be selected from the group consisting of tricyclodecane dimethanol diacrylate, isobornyl acrylate, 2-norbornyl (meth)acrylate, dicyclopentenyl (meth)acrylate, tricyclodecyl (meth)acrylate, trimethylnorbornyl cyclohexyl (meth)acrylate, dihydrodicyclopentadienyl acrylate, 2-(2-ethoxyethoxy) ethyl acrylate, tripropylene glycol diacrylate, trimethylolpropane ethoxy triacrylate, ethylene glycol dicyclopentenyl ether (meth)acrylate, methylbicycloheptyl (meth)acrylate, ethyltricyclodecyl (meth)acrylate, adamantanyl (meth)acrylate, methyladamantanyl (meth)acrylate, ethyladamantanyl (meth)acrylate, hydroxymethyl adamantanyl (meth)acrylate, 3-hydroxy-1-adamantanyl (meth)acrylate, methoxybutyl adamantanyl (meth)acrylate, carboxyl adamantanyl (meth)acrylate, 5-oxo-4-oxatricyclo[4.2.1.03,7]nonan-2-ylprop-2-enoate, 7-oxabicyclo[4.1.0]heptane-3-ylmethylprop-2-enoate, tripropyleneglycol-diacrylate, neopentylglycol diacrylate, 3-methyl-1,5-pentanediol diacrylate, 1,6-hexanediol diacrylate, hydroxypivalaldehyde-modified trimethylolpropane diacrylate, tert-butyl methacrylate, cyclohexyl methacrylate, N,N-dimethylacrylamide, N-isopropylacrylamide, phenylacrylamide, t-butylacrylamide, N-methylacrylamide, N-hydroxyethylacrylamide, bisphenol A diacrylate, glycerin tri(meth)acrylate, trimethylolpropane tri(meth)acrylate, pentaerythritol tri(meth)acrylate, monoester of pentaerythritol tri(meth)acrylate and succinic acid, pentaerythritol tetra(meth)acrylate, dipentaerythritol penta(meth)acrylate, dipentaerythritol hexa(meth)acrylate, monoester of dipentaerythritol penta(meth)acrylate and succinic acid, caprolactone-modified dipentaerythritol hexa(meth)acrylate, pentaerythritol triacrylate hexamethylene diisocyanate (a reaction product of pentaerythritol triacrylate and hexamethylene diisocyanate), tripentaerythritol hepta(meth)acrylate, tripentaerythritol octa(meth)acrylate, bisphenol A epoxyacrylate, and ethylene glycol monomethyl ether acrylate, but it is not limited thereto. According to an embodiment, it may be trimethylolpropane tri(meth)acrylate or dipentaerythritol penta(meth)acrylate.

In addition, the curable composition may comprise the (meth)acrylate-based crosslinking agent in an amount of 0.5% by weight to 40% by weight based on solids content. For example, the curable composition may comprise the (meth)acrylate-based crosslinking agent in an amount of 1% by weight to 38% by weight, 2% by weight to 36% by weight, 3% by weight to 35% by weight, 5% by weight to 34.5% by weight, 7% by weight to 34% by weight, 10% by weight to 33.5% by weight, 11.5% by weight to 33.5% by weight, 12.1 to 33.5% by weight, or 12.3% by weight to 33.4% by weight, based on solids content.

### (C) Photopolymerization Initiator

The curable composition of the present invention comprises a photopolymerization initiator.

The photopolymerization initiator may comprise a phosphine oxide-based, benzoin-based, benzophenone-based, acetophenone-based, oxime-based, ketone-based, biimidazole-based, diazo-based, carbazole-based, triazine-based, onium salt-based, thioxanthone-based, imide sulfonate-based compound, or derivatives thereof. Preferred are phosphine oxide-based compounds or derivatives thereof, but it is not limited thereto.

For examples, the photopolymerization initiator may comprise diphenyl(2,4,6-trimethylbenzoyl)phosphine oxide, (2,4,6-trimethylbenzoyl)diphenylphosphine oxide, bis(2,4,6-trimethylbenzoyl)phenylphosphine oxide, ethyl (3-benzoyl-2,4,6-trimethylbenzoyl)phenylphosphinate, phenyl bis(2,4,6-trimethylbenzoyl)phosphine oxide, 2-hydroxy-2-methyl-1-phenylpropanone, 2,2′-azobis(2,4-dimethylvaleronitrile), 2,2′-azobis(4-methoxy-2,4-dimethylvaleronitrile), benzoyl peroxide, lauryl peroxide, t-butyl peroxy pivalate, 1,1-bis(t-butylperoxy)cyclohexane, p-dimethylaminoacetophenone, 2-benzyl-2-(dimethylamino)-1-[4-(4-morpholinyl)phenyl]-1-butanone, 2-hydroxy-2-methyl-1-phenyl-propan-1-one, benzyl dimethyl ketal, benzophenone, benzoin propyl ether, diethyl thioxanthone, 2,4-bis(trichloromethyl)-6-p-methoxyphenyl-s-triazine, 2-trichloromethyl-5-styryl-1,3,4-oxodiazole, 9-phenylacridine, 3-methyl-5-amino-((s-triazin-2-yl)amino)-3-phenylcoumarin, 2-(o-chlorophenyl)-4,5-diphenylimidazolyl dimer, 1-phenyl-1,2-propanedione-2-(o-ethoxycarbonyl)oxime, 1-[4-(phenylthio)phenyl]-octane-1,2-dione-2-(o-benzoyloxime), o-enzoyl-4′-(benzmercapto)benzoyl-hexyl-ketoxime, 2,4,6-trimethylphenylcarbonyl-diphenylphosphonyloxide, hexafluorophosphoro-trialkylphenylsulfonium salt, 2-mercaptobenzimidazole, 2,2′-benzothiazolyl disulfide, (E)-2-(4-styrylphenyl)-4,6-bis(trichloromethyl)-1,3,5-triazine, 2-dimethylamino-2-(4-methylbenzyl)-1-(4-morpholin-4-ylphenyl)-butane-1-one, or a mixture thereof.

According to an embodiment, the photopolymerization initiator may comprise diphenyl(2,4,6-trimethylbenzoyl)phosphine oxide, (2,4,6-trimethylbenzoyl)diphenylphosphine oxide, bis(2,4,6-trimethylbenzoyl)phenylphosphine oxide, ethyl (3-benzoyl-2,4,6-trimethylbenzoyl)phenylphosphinate, phenyl bis(2,4,6-trimethylbenzoyl)phosphine oxide, 2-hydroxy-2-methyl-1-phenylpropanone, or a combination thereof.

Examples of the commercially available photopolymerization initiators include diphenyl(2,4,6-trimethylbenzoyl)phosphine oxide, 2,4,6-trimethylbenzoyl-diphenylphosphine oxide, bis(2,4,6-trimethylbenzoyl)phenylphosphine oxide (OMNIRAD™ TPO, IGM Resins products), and ethyl (3-benzoyl-2,4,6-trimethylbenzoyl)phenylphosphinate (SPEEDCURE™ XKm, Lambson Limited products).

In addition, the curable composition may comprise the photopolymerization initiator in an amount of 0.01% by weight to 5% by weight based on solids content. For example, the curable composition may comprise the photopolymerization initiator in an amount of 0.05% by weight to 3.5% by weight, 0.1% by weight to 3% by weight, 0.3% by weight to 2.5% by weight, 0.8% by weight to 2.2% by weight, 1% by weight to 2% by weight, 1.1% by weight to 1.6% by weight, or 1.25% by weight to 1.4% by weight, based on solids content.

### (D) Acrylamide Compound

The curable composition of the present invention may further comprise an acrylamide compound.

Specifically, the acrylamide compound may comprise at least one selected from the group consisting of N,N-dimethylacrylamide, N,N-diethylacrylamide, acryloylmorpholine, N,N-isopropylacrylamide, phenylacrylamide, tert-butylacrylamide, N-methylacrylamide, and N-hydroxyethylacrylamide. Acryloylmorpholine may be preferred from the viewpoint of adhesion, but it is not limited thereto.

In addition, the curable composition may comprise the acrylamide compound in an amount of 0.5% by weight to 20% by weight based on solids content. For example, the curable composition may comprise the acrylamide compound in an amount of 0.5% by weight to 18% by weight, 0.7% by weight to 16% by weight, 0.8% by weight to 13% by weight, 1% by weight to 11% by weight, 2.5% by weight to 10.5% by weight, 3.5% by weight to 10% by weight, 3.9 to 9.9% by weight, 4.5% by weight to 9.9% by weight, 5% by weight to 9.9% by weight, 4.5% by weight to 10% by weight, or 4% by weight to 9.9% by weight, based on solids content.

### Additive

The curable composition of the present invention may further comprise at least one component selected from the group consisting of surfactants, toughening agents, silane coupling agents, and free radical inhibitors.

The curable composition of the present invention, if necessary, may further comprise a surfactant in order to enhance curability or coatability and to prevent the generation of defects.

The kind of surfactant is not particularly limited. Preferably, it may include fluorine-based surfactants, silicone-based surfactants, non-ionic surfactants, and the like. Preferably, BYK 307 from BYK among the above may be employed from the viewpoint of dispersibility.

For example, the surfactant may comprise a fluorine-based surfactant, a silicone-based surfactant, and a non-ionic surfactant such as polyoxyethylene alkyl ethers such as polyoxyethylene lauryl ether, polyoxyethylene stearyl ether, polyoxyethylene oleyl ether, and the like; polyoxyethylene aryl ethers such as polyoxyethylene octylphenyl ether, polyoxyethylene nonylphenyl ether, and the like; and polyoxyethylene dialkyl esters such as polyoxyethylene dilaurate, polyoxyethylene distearate, and the like.

Examples of the commercially available surfactant include BM-1000 and BM-1100 (BM CHEMIE products), Megapack F-142 D, Megapack F-172, Megapack F-173, Megapack F-183, F-470, F-471, F-475, F-482, and F-489 (Dai Nippon Ink Chemical Kogyo products), Florad FC-135, Florad FC-170 C, Florad FC-430, and Florad FC-431 (Sumitomo 3M products), Sufron S-112, Sufron S-113, Sufron S-131, Sufron S-141, Sufron S-145, Sufron S-382, Sufron SC-101, Sufron SC-102, Sufron SC-103, Sufron SC-104, Sufron SC-105, and Sufron SC-106 (Asahi Glass products), Eftop EF301, Eftop EF303, and Eftop EF352 (Shinakida Kasei products), SH-28 PA, SH-190, SH-193, SZ-6032, SF-8428, DC-57, and DC-190 (Toray Silicon products), DC3PA, DC7PA, SH11PA, SH21PA, SH8400, FZ-2100, FZ-2110, FZ-2122, FZ-2222, and FZ-2233 (Dow Corning Toray Silicon products), TSF-4440, TSF-4300, TSF-4445, TSF-4446, TSF-4460, and TSF-4452 (GE Toshiba Silicon products), BYK-333 (BYK products), organosiloxane polymer KP341 (Shin-Etsu Chemical Co., Ltd. products), and (meth)acrylic acid copolymer Polyflow No. 57, 95 (Kyoeisha Yuji Kagaku Kogyo Co., Ltd. products). They may be used alone or in combination of two or more thereof.

In addition, the curable composition may comprise the surfactant in an amount of 0.001% by weight to 5% by weight based on solids content. For example, the curable composition may comprise the surfactant in an amount of 0.001% by weight to 3% by weight, 0.002% by weight to 2% by weight, or 0.005% by weight to 1.2% by weight, based on solids content.

The curable composition may further comprise at least one toughening agent selected from the group consisting of an epoxy compound, a polyether compound, and a polyetheramine.

For example, the toughening agent may comprise an epoxy compound such as 3,4-epoxycyclohexylmethyl-3,4′-epoxycyclohexane carboxylate, a polyether compound, ethyleneoxy and propyleneoxy or ethyleneoxy and butyleneoxy copolymer, polyether amines such as poly(propylene glycol) bis(2-aminopropylether), trimethylolpropane tris[poly(propylene glycol), amine-terminated] ethers, and the like.

Examples of the commercially available toughening agent include FORTEGRA™ 100, FORTEGRA™ 202, TERGITOL L-61™ 100 (Dow Chemical Company products), PLURONIC™, TETRONIC™, PolyTHF™ (BASF products), JEFFAMINE™ D230, JEFFAMINE™ T403 (Huntsman products), and the like.

The free radical inhibitor may be, for example, 4-methoxylphenol (MEHQ), phenothiazine (PTZ), 4-hydroxyl-TEMPO (4HT), or the like, but it is not limited thereto.

The silane coupling agent may have at least one functional group selected from the group consisting of a carboxyl group, an acryloyl group, a methacryloyl group, an isocyanate group, an amino group, a mercapto group, a vinyl group, an epoxy group, and a combination thereof.

For example, the silane coupling agent may comprise at least one selected from the group consisting of γ-methacryloxypropyltrimethoxysilane, vinyltriacetoxysilane, vinyltrimethoxysilane, γ-isocyanatopropyltriethoxysilane, γ-glycidoxypropyltrimethoxysilane, γ-glycidoxypropyltriethoxysilane, N-phenylaminopropyltrimethoxysilane, and β-(3,4-epoxycyclohexyl)ethyltrimethoxysilane.

In addition, the silane coupling agent may comprise an amine-based silane coupling agent. Specifically, it may comprise an amine-based silane coupling agent represented by the following Formula 2.

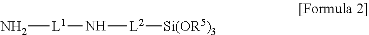

In Formula 2, L¹ and L² are each independently a C₁₋₆ alkylene group, and R⁵ is a C₁₋₆ alkyl group.

Specifically, L¹ and L² may each independently be a C₁₋₄ alkylene group or a C₁₋₃ alkylene group. R⁵ may be a C₁₋₅ alkyl group, a C₁₋₄ alkyl group, or a C₁₋₃ alkyl group. More specifically, R⁵ may be a methyl group or an ethyl group.

As the curable composition comprises the silane coupling agent, reliability can be enhanced. Specifically, as the curable composition of the present invention comprises an amine-based silane coupling agent, more specifically, further comprises an amine-based silane coupling agent represented by Formula 2, it is possible to enhance the film retention rate and effectively prevent a phenomenon such as buckling in which a film is delaminated from the lower substrate even when a repeated bending test is performed under high temperature and high humidity conditions, thereby maximizing reliability.

In addition, the curable composition may comprise the silane coupling agent in an amount of 0.01% by weight to 7% by weight based on solids content. For example, the curable composition may comprise the silane coupling agent in an amount of 0.01% by weight to 6.5% by weight, 0.01% by weight to 6% by weight, 0.02% by weight to 5% by weight, 0.02% by weight to 4% by weight, 0.02% by weight to 3.5% by weight, 0.05% by weight to 3% by weight, or 1% by weight to 3% by weight, based on solids content.

### Solvent

The curable composition of the present invention may be prepared as a liquid composition in which the above components are mixed with a solvent. The solvent, as a carrier, may be an organic solvent (including a mixture of organic solvents).

For example, the solvent may comprise propylene glycol methyl ether; ether acetates such as propylene glycol methyl acetate; ketones such as methyl isobutyl ketone, methyl ethyl ketone, methyl propyl ketone, methyl isoamyl ketone, and dimethyl ketone; esters such as methyl-2-hydroxyl isobutyrate, ethyl acetate, and butyl acetate; alcohols such as methanol and butanol; or mixtures thereof, but it is not limited thereto.

The content of the solvent is not particularly limited, but it may be 10% by weight to 90% by weight, 15% by weight to 85% by weight, or 30% by weight to 85% by weight, based on the total weight of the curable composition.

### Photoacid Generator, Photobase Generator, and Thermal Acid Generator

The curable composition of the present invention may comprise at least one selected from the group consisting of a photoacid generator, a photobase generator, and a thermal acid generator.

The photoacid generator becomes acidic when exposed to light; thus, it may act as a photoinitiator for an acid-catalyzed reaction. It may be ionic or nonionic. The photoacid generator may comprise an onium salt, a nonionic sulfonate, or a sulfonic acid compound.

For example, the photoacid generator may be onium salts such as triphenylsulfonium (p-tert-butoxyphenyl)diphenylsulfonium trifluoromethanesulfonate, trifluoromethanesulfonate, tris(p-tert-butoxyphenyl)sulfonium trifluoromethanesulfonate, triphenylsulfonium p-toluenesulfonate, di-t-butylphenyliodonium perfluorobutanesulfonate, and di-t-butylphenyliodonium camphorsulfonate; nitrobenzyl derivatives such as 2-nitrobenzyl-p-toluenesulfonate, 2,6-dinitrobenzyl-p-toluenesulfonate, and 2,4-dinitrobenzyl-p-toluenesulfonate; sulfonic acid esters such as 1,2,3-tris(methanesulfonyloxy)benzene, 1,2,3-tris(trifluoromethanesulfonyloxy)benzene, and 1,2,3-tris(p-toluenesulfonyloxy)benzene; diazomethane derivatives such as bis(benzenesulfonyl)diazomethane and bis(p-toluenesulfonyl)diazomethane; glyoxime derivatives such as bis-O-(p-toluenesulfonyl)-α-dimethylglyoxime and bis-O-(n-butanesulfonyl)-α-dimethylglyoxime; sulfonic acid ester derivatives of N-hydroxyimide compounds such as N-hydroxynaphthalimide triflate, N-hydroxysuccinimide methanesulfonic acid ester, and N-hydroxysuccinimide trifluoromethanesulfonic acid ester; and halogen-containing triazine compounds such as 2-(4-methoxyphenyl)-4,6-bis(trichloromethyl)-1,3,5-triazine and 2-(4-methoxynaphthyl)-4,6-bis(trichloromethyl))-1,3,5-triazine, but it is not limited thereto.

As a specific example, the photoacid generator may comprise at least one selected from the group consisting of N-hydroxynaphthalimide triflate, triphenylsulfonium trifluoromethanesulfonate, (p-tert-butoxyphenyl)diphenylsulfonium trifluoromethanesulfonate, tris(p-tert-butoxyphenyl)sulfonium trifluoromethanesulfonate, triphenylsulfonium p-toluenesulfonate, di-t-butylphenyliodonium perfluorobutanesulfonate, di-t-butylphenyliodonium camphorsulfonate, 2-(4-methoxynaphthyl)-4,6-bis(trichloromethyl)-1,3,5-triazine, 2-nitrobenzyl-p-toluenesulfonate, 2,6-dinitrobenzyl-p-toluenesulfonate, 2,4-dinitrobenzyl-p-toluenesulfonate, 1,2,3-tris(methanesulfonyloxy)benzene, 1,2,3-tris(trifluoromethanesulfonyloxy)benzene, 1,2,3-tris(p-toluenesulfonyloxy)benzene, bis(benzenesulfonyl)diazomethane, bis(p-toluenesulfonyl)diazomethane, bis-O-(p-toluenesulfonyl)-α-dimethylglyoxime, bis-O-(n-butanesulfonyl)-α-dimethylglyoxime, N-hydroxysuccinimide methanesulfonic acid ester, N-hydroxysuccinimide trifluoromethanesulfonic acid ester, and 2-(4-methoxyphenyl)-4,6-bis(trichloromethyl)-1,3,5-triazine.

The photobase generator may comprise a compound having the property of generating a base upon the irradiation of light (or an activated energy ray). For example, the photobase generator may comprise a highly sensitive compound having a photosensitive range even at a wavelength of 300 nm or more.

The photobase generator may comprise a crosslinkable compound comprising a polyamine photobase generator component. Since the photobase generator generates a base upon the irradiation of light (e.g., UV), it is not inhibited by oxygen in the air, so that it is useful for preventing corrosion or deterioration.

Examples of the photobase generator include WPBG-018 (Wako products, CAS No. 122831-05-7, 9-anthrimethyl-N,N-diethylcarbamate), WPBG-027 (CAS No. 1203424-93-4, (E)-1-piperidino-3-(2-hydroxyphenyl)-2-propen-1-one), WPBG-266 (CAS No. 1632211-89-2, 1,2-diisopropyl-3-[bis(dimethylamino)methylene]guanidium 2-(3-benzoylphenyl)propionate), WPBG-300 (CAS No. 1801263-71-7, 1,2-dicyclohexyl-4,4,5,5-tetramethylbiguanidinium n-butyltriphenylborate), and the like. The photobase generator may be used alone or in combination of two or more thereof.

The thermal acid generator refers to a compound that generates an acid at a specific temperature. Such a compound is composed of an acid-generating part and acid-blocking part that blocks the acid properties. When the thermal acid generator reaches a specific temperature, the acid-generating part may be separated from the acid-blocking part to generate acid.

The thermal acid generator may comprise amines, quaternary ammoniums, metals, covalent bonds, or the like as an acid-blocking part and may specifically comprise amines or quaternary ammoniums. In addition, the acid-generating part may comprise sulfonic acid salts, phosphate salts, carboxylate salts, antimonate salts, or the like.

Thermal acid generators containing an amine as an acid-blocking part have the advantage of being highly soluble in water or polar solvents and being applicable to non-solvent-type products. In addition, not only can an acid be generated in a wide temperature range, but the amine compound after the generation of an acid is volatilized not to remain in the applied material. Examples of the representative thermal acid generators containing an amine include TAG-2713S, TAG-2713, TAG-2172, TAG-2179, TAG-2168E, CXC-1615, CXC-1616, TAG-2722, CXC-1767, and CDX-3012 (KING Industries products).

Thermal acid generators containing a quaternary ammonium as an acid-blocking part are in a solid state in the form of a white powder and have relatively limited solubility in solvents. However, there are various types having onset temperatures within the range of 80° ° C. to 220° C., which involves an advantage in that a thermal acid generator comprising a quaternary ammonium with a required onset temperature can be appropriately selected and used according to the application process. In addition, in the thermal acid generator containing a quaternary ammonium as an acid-blocking part, the compound formed after the generation of an acid is not volatilized to remain in the applied material; thus, it is mainly applicable to hydrophobic materials. Examples of the representative thermal acid generators containing a quaternary ammonium include CXC-1612, CXC-1733, CXC-1738, TAG-2678, CXC-1614, TAG-2681, TAG-2689, TAG-2690, and TAG-2700 (KING Industries products).

There are various types of thermal acid generators containing an amine or a quaternary ammonium as an acid-blocking part and are most commonly used by virtue of the above-mentioned advantages.

Thermal acid generators containing metals as an acid-blocking part generally contain monovalent or divalent metal ions. Most of them act as a catalyst and can be applied to both hydrophobic and hydrophilic materials. Examples of the thermal acid generators containing metals include CXC-1613, CXC-1739, and CXC-1751 (KING Industries products). Some thermal acid generators containing metals may be used limitedly in consideration of environmental impacts or reliability.

In thermal acid generators containing a covalent bond as an acid-blocking part, the compound formed after the generation of an acid is not volatilized to remain in the applied material; thus, it is mainly applicable to hydrophobic materials. In general, they have a stable structure whereas they have a relatively limited solubility in solvents, so that their uses are limited. Examples of the thermal acid generators containing a covalent bond include CXC-1764, CXC-1762, and TAG-2507 (KING Industries products).

In addition, the curable composition may comprise the photoacid generator, photobase generator, or thermal acid generator in an amount of 0.1% by weight to 20% by weight based on solids content. For example, the content of the photoacid generator, photobase generator, or thermal acid generator may be 0.2% by weight to 18% by weight, 0.3% by weight to 15% by weight, 0.5% by weight to 10% by weight, or 1% by weight to 8% by weight, based on solids content.

### Film

The present invention provides a film formed from the curable composition.

Specifically, the curable composition may be used as a coating composition that can be applied to the surface of various substrates and then cured. Once it has been applied to the surface of a substrate and cured, it may be peeled off to form a film.

The substrate may be a substrate suitable for use in the display field; for example, a silicon wafer, a glass slide, a polymer sheet or roll, a polymer film, or the like may be used, but it is not limited thereto. The polymer film may be polyethylene terephthalate, polycarbonate, polymethyl methacrylate, polyethylene naphthalate, cyclic olefin polymer or cyclic olefin copolymer, aliphatic polyurethane, or polyimide, but it is not limited thereto.

The method of applying the curable composition to a substrate may be draw-down bar coating, wire bar coating, slot die coating, roll-to-roll coating, slit coating, flexographic printing, imprinting, spray coating, dip coating, spin coating, flood coating, flow coating, screen printing, inkjet printing, gravure coating, or the like, but it is not limited thereto.

For example, once the curable composition has been applied to a substrate, it may be soft-baked or post-baked at a temperature of 60° C. to 150° C., 70° C. to 120° C., or 70° C. to 90° ° C. to remove any solvent. Soft-baking may be followed by post-baking.

In addition, it may be cured by exposure to ultraviolet (UV) having a wavelength of 240 nm to 400 nm at a UV dose of 200 mJ/cm² to 8,000 mJ/cm², 400 mJ/cm² to 6,000 mJ/cm², or 500 mJ/cm² to 4,500 mJ/cm², to form a film. In such an event, a Fusion D light bulb, H UV lamp, or medium-pressure mercury UV lamp may be used as the UV system, but it is not limited thereto.

The film has a glass transition temperature (Tg) of −60° C. to −10° C. when measured using a dynamic mechanical analyzer (DMA). For example, the glass transition temperature of the film may be −60° C. to −15° C., −59° C. to −20° C., −58° C. to −23° C., or −57° C. to −26° ° C. If the glass transition temperature satisfies the above range, it is possible to maximize flexibility and pliability. More specifically, it is possible to effectively prevent a phenomenon such as buckling in which a film is delaminated from the lower substrate even when a repeated bending test is performed under high temperature and high humidity conditions, thereby maximizing reliability.

The glass transition temperature may be measured using a dynamic mechanical analyzer. The peak temperature measured for the film through a dynamic mechanical analyzer may be taken as the glass transition temperature.

In addition, the film may have a storage modulus at −20° ° C. of 20 MPa to 595 MPa and a storage modulus at 60° C. of 1 MPa to 350 MPa. For example, the storage modulus at −20° C. of the film may be 30 MPa to 590 MPa, 70 MPa to 585 MPa, 100 MPa to 585 MPa, 160 MPa to 585 MPa, 175 MPa to 570 MPa, 190 MPa to 565 MPa, or 210 MPa to 500 MPa, and the storage modulus at −60° C. thereof may be 3 MPa to 335 MPa, 10 MPa to 325 MPa, 25 MPa to 305 MPa, 30 MPa to 290 MPa, 33 MPa to 260 MPa, 35 MPa to 200 MPa, 36 MPa to 180 MPa, 38 MPa to 155 MPa, 40 MPa to 130 MPa, 42 MPa to 102 MPa, 42 MPa to 85 MPa, or 44 MPa to 77 MPa. As the film prepared from the curable composition of the present invention has a storage modulus at −20° C. and a storage modulus at 60° C. each satisfying the above ranges, it is excellent in all of impact resistance, scratch resistance, flexibility, and pliability.

The film may have a thickness of 40 μm to 130 μm. For example, the thickness of the film may be 40 μm to 110 μm, 40 μm to 95 μm, 40 μm to 80 μm, 42 μm to 65 μm, 42 μm to 55 μm, or 43 μm to 50 μm.

In addition, when the film is subjected to a repeated bending test by in-folding 100,000 times with a curvature radius of 1.5 R at room temperature, whitening and cracks do not take place; thus, it can be advantageously applied to a flexible display device.

### MODE FOR THE INVENTION

Hereinafter, the present invention will be described in more detail with reference to the following examples. However, these examples are provided to illustrate the present invention, and the scope of the present invention is not limited thereto only.

### Example

### Preparation of a Curable Composition

### Examples 1-1 to 1-10 and Comparative Examples 1-1 to 1-5

The components shown in Table 1 were compounded as shown in Tables 2 to 4 to prepare a curable composition. All the components were used as received, and the components were weighed and added to a glass vial. The composition was rolled and heated, if necessary, to obtain a homogeneous sample.

In such an event, information on the components used in the Examples and Comparative Examples is shown in Table 1 below, and the numbers in Tables 2 to 4 indicate parts by weight.

TABLE 1

| | Compound name | Manu- |
|---|---|---|
| | and/or brand name | facturer |
| Urethane | 2-Hydroxyethyl acrylate, | Shin-A |
| (meth)acrylate | 5-isocyanato-1- | |
| oligomer (A-1) | (isocyanatomethyl)-1,3,3- | |
| | trimethylcyclohexane, | |
| | 2-methyloxirane | |
| | (brand name: SUO-2172) | |
| Urethane | 2-Hydroxyethyl acrylate, bis(4- | Shin-A |
| (meth)acrylate | isocyanatocyclohexyl)methane, | |
| oligomer (A-2) | 2-methyloxirane | |
| | (brand name: SUO-M2000) | |
| Urethane | 2-Hydroxyethyl acrylate, | Shin-A |
| (meth)acrylate | hexamethylene-1,6-diisocyanate, | |
| oligomer (A-3) | 2-methyloxirane | |
| | (brand name: SUO-H7000) | |
| Urethane | 2-Hydroxyethyl (meth)acrylate, | Shin-A |
| (meth)acrylate | 5-isocyanato-1- | |
| oligomer (A-4) | (isocyanatomethyl)-1,3,3- | |
| | trimethylcyclohexane, | |
| | 2,2,4,4,6,6,8,8- | |
| | octamethyl-1,3,5,7,2,4,6,8- | |
| | tetraoxatetrasilokane | |
| | (brand name: SUO-S3000) | |
| Urethane | 2-Hydroxyethyl acrylate, | Shin-A |
| (meth)acrylate | polyethylene glycol, | |
| oligomer (A-5) | polycarbonate diol | |
| | (brand name: SUO-1202120) | |
| Urethane | 2-Hydroxyethyl acrylate, | Sartomer |
| (meth)acrylate | hexamethylene-1,6- | |
| oligomer (A-6) | diisocyanate, secret polyol | |
| | (brand name: CN8893) | |
| (Meth)acrylate- | Trimethylolpropane triacrylate | ENTIS |
| based crosslinking | | |
| agent (B-1) | | |
| (Meth)acrylate- | Tricyclododecane dimethanol | Sartomer |
| based crosslinking | diacrylate | |
| agent (B-2) | | |
| (Meth)acrylate- | Ethoxylated pentaerythritol | Nippon |
| based crosslinking | tetraacrylate | Kayaku |
| agent (B-3) | | |
| Photo- | Bis(2,4,6-trimethyl- | IGM |
| polymerization | benzoyl)phenylphosphine oxide | Resins |
| initiator (C-1) | (brand name: OMNIRAD ™819) | |
| Photo- | 2-Hydroxy-2-methyl-1- | IGM |
| polymerization | phenylpropan-1-one, (2,4,6- | Resins |
| initiator (C-2) | trimethylbenzoyl)diphenylphosphine | |
| | oxide (brand name: | |
| | OMNIRAD ™4265) | |
| Acrylamide | 4-Acryloylmorpholine | Sigma- |
| compound (D) | | Aldrich |
| Surfactant (E) | Brand name: BYK 307 | BYK |
| Amine-based | N-(3- | Evonik |
| silane coupling | (trimethoxysilyl)propyl) | |
| agent (F-1) | ethylenediamine | |
| Amine-based | N1-[2-(trimethoxysilyl)ethyl]- | Chemieliva |
| silane coupling | 1,2-ethanediamine | |
| agent (F-2) | | |
| Solvent (G) | Methyl isobutyl ketone | KUMHO |
| | | P&B |

TABLE 2

| | Example | Example | Example | Example | Example |
|---|---|---|---|---|---|
| | 1-1 | 1-2 | 1-3 | 1-4 | 1-5 |
| A-1 | 100 | — | — | 100 | 100 |
| A-2 | — | 100 | — | — | — |
| A-3 | — | — | 100 | — | — |
| B-1 | 8.69 | 8.47 | 8.47 | 15.41 | 5.79 |
| B-2 | 22.63 | 22.06 | 22.06 | 40.32 | 154.16 |
| B-3 | 2.99 | 2.92 | 2.92 | 5.32 | 2.07 |
| C-1 | 0.70 | 0.69 | 0.69 | 0.80 | 0.58 |
| C-2 | 1.35 | 1.34 | 1.34 | 1.54 | 1.12 |
| D | 10.11 | 9.86 | 9.86 | 18.07 | 6.75 |
| E | 0.02 | 0.01 | 0.01 | 0.02 | 0.01 |
| F-1 | 0.15 | 1.47 | 1.47 | 1.68 | 1.22 |
| F-2 | — | — | — | — | — |
| G | 85 | 85 | 85 | 85 | 85 |

TABLE 3

| | Example | Example | Example | Example | Example |
|---|---|---|---|---|---|
| | 1-6 | 1-7 | 1-8 | 1-9 | 1-10 |
| A-1 | 100 | 100 | 100 | 100 | 100 |
| A-2 | — | — | — | — | — |
| A-3 | — | — | — | — | — |
| B-1 | 4.12 | 8.69 | 8.69 | 8.69 | 8.69 |
| B-2 | 10.83 | 22.63 | 22.63 | 22.63 | 22.63 |
| B-3 | 1.42 | 2.99 | 2.99 | 2.99 | 2.99 |
| C-1 | 0.54 | 0.70 | 0.70 | 0.70 | 0.7 |
| C-2 | 1.04 | 1.35 | 1.35 | 1.35 | 1.35 |
| D | 4.90 | 10.11 | 10.11 | 10.11 | 10.11 |
| E | 0.01 | 0.02 | 0.02 | 0.02 | 0.02 |
| F-1 | 1.14 | 1.48 | 4.53 | — | 9.35 |
| F-2 | — | — | — | 1.48 | — |
| G | 85 | 85 | 85 | 85 | 85 |

TABLE 4

| | Comparative | Comparative | Comparative | Comparative |
|---|---|---|---|---|
| | Example 1-1 | Example 1-2 | Example 1-3 | Example 1-4 |
| A-1 | 100 | — | — | — |
| A-4 | — | 100 | — | — |
| A-5 | — | — | 100 | — |
| A-6 | — | — | — | 100 |
| B-1 | 29.454 | 8.36 | — | — |
| B-2 | 76.64 | 21.75 | — | — |
| B-3 | 10.11 | 2.88 | 19.54 | 19.54 |
| C-1 | 1.12 | 0.69 | 0.64 | 0.64 |
| C-2 | 2.16 | 1.34 | 1.24 | 1.24 |
| D | 34.33 | 9.72 | 13.03 | 13.03 |
| E | 0.03 | 0.02 | 0.01 | 0.01 |
| F-1 | 2.36 | 1.46 | 1.36 | 1.36 |
| G | 85 | 85 | 100 | 100 |

Preparation of a Film from the Curable Composition

### Examples 2-1 to 2-10 and Comparative Examples 2-1 to 2-4

The curable compositions prepared in Examples 1-1 to 1-10 and Comparative Examples 1-1 to 1-4 were each applied using a slot die coater (nTact nRad coater) onto a release substrate to a thickness of 40 μm to 130 μm. Thereafter, the solvent was removed through a soft-bake and post-bake process at 90° C., and each coated film was cured using a fusion UV curing system (F300S) equipped with a D bulb (radiation energy output of 100 nm to 440 nm). Specifically, the belt speed of the mounted conveyor was set at about 15.25 m/minute (about 50 ft/minute), and it passed through the UV belt several times to reach a UV dose of 500 mJ/cm² to 4,500 mJ/cm² for sufficient curing.

Thereafter, the cured film was baked at 90° ° C. for 15 minutes to remove all residual organic solvents and unreacted monomers. Then, the cured urethane (meth)acrylate coating was peeled off from the release substrate using a razor blade to obtain a film, which was evaluated. However, the following repeated bending test was carried out for films prepared using a PET substrate instead of a release substrate.

### Test Example

### Test Example 1: Storage Modulus

The films prepared in Examples 2-1 to 2-10 and Comparative Examples 2-1 to 2-4 were each cut into a size of 10 mm in width and 50 mm in length, which was measured for the storage modulus (MPa) using a dynamic mechanical analyzer (DMA, product name: Q850, manufacturer: TA Instrument) at −20° C. and 60° C. and a frequency of 1 Hz in the vibration mode (oscillation temperature ramp mode).

### Test Example 2: Glass Transition Temperature

The films prepared in Examples 2-1 to 2-10 and Comparative Examples 2-1 to 2-4 were each cut into a size of 10 mm in width and 50 mm in length, which was measured for the glass transition temperature (Tg) using a dynamic mechanical analyzer (DMA, product name: Q850, manufacturer: TA Instrument) at a frequency of 1 Hz in a temperature range of −70° C. to 100° C. in the vibration mode (oscillation temperature ramp mode).

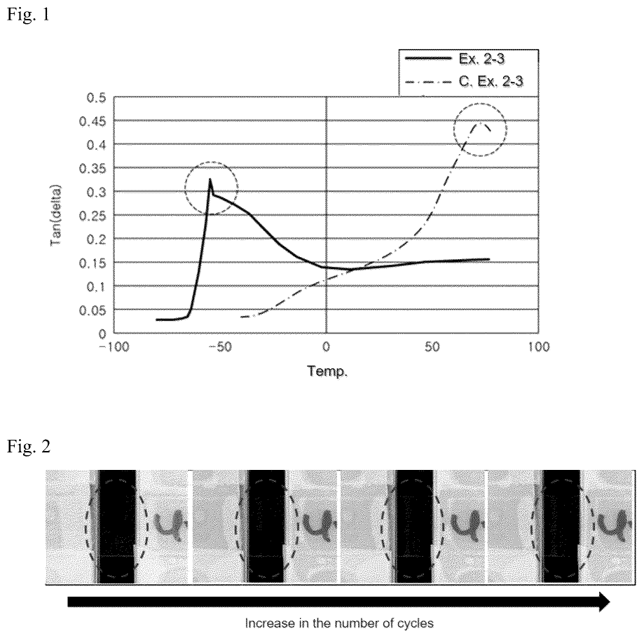

FIG. 1 shows the glass transition temperature (Tg) of the films of Example 2-3 and Comparative Example 2-3 measured using a dynamic mechanical analyzer (DMA). Specifically, as shown in FIG. 1, the temperature at which a peak appears was taken as the glass transition temperature (Tg).

### Test Example 3: Repeated Bending Test 1

The films prepared in Examples 2-1 to 2-10 and Comparative Examples 2-1 to 2-4 were each cut into a size of 10 mm in width and 50 mm in length, which was subjected to a repeated bending test by in-folding 100,000 times with a curvature radius of 1.5 R in a clamshell type at room temperature using a folding durability tester (product name: Foldy, manufacturer: Flexigo). Then, whitening and cracks were evaluated by the following criteria.
Pass: No cracks were observed
Failure: Cracks were observed

### Test Example 4: Repeated Bending Test 2

The films prepared in Examples 2-1 to 2-10 and Comparative Examples 2-1 to 2-4 were each cut into a size of 10 mm in width and 50 mm in length, which was subjected to a repeated bending test by in-folding 100,000 times with a curvature radius of 1.5 R in a clamshell type using a folding durability tester (product name: Foldy, manufacturer: Flexigo) before and after 60 hours had elapsed in a chamber under high temperature and high humidity conditions (temperature 60° C. and humidity 90%).
Pass: No cracks were observed
Failure: Cracks were observed

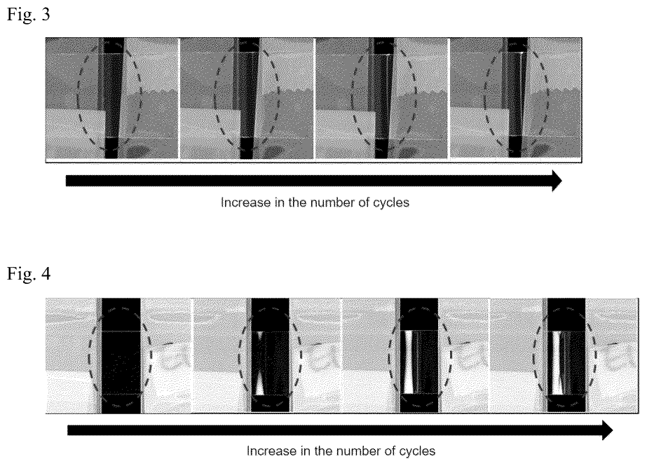

FIGS. 2 to 4 are photographs of the surfaces of the films in Example 2-3 and Comparative Examples 2-1 and 2-3 subjected to the repeated bending test 2. Specifically, the films of Example 2-3 and Comparative Examples 2-1 and 2-3 were each subjected to a repeated bending test by in-folding 100,000 times after 60 hours had elapsed in a chamber under high temperature and high humidity conditions (temperature 60° C. and humidity 90%) to check whether cracks were formed.

TABLE 5

| | | Example | Example | Example | Example | Example |
|---|---|---|---|---|---|---|
| | | 2-1 | 2-2 | 2-3 | 2-4 | 2-5 |
| Storage modulus | −20° C. | 230 | 561 | 216 | 498 | 219 |
| (MPa) | 60° C. | 54 | 102 | 42 | 77 | 44 |
| Tg (° C.) | | −52 | −34 | −26 | −41 | −52 |
| Repeated bending test 1 | | Pass | Pass | Pass | Pass | Pass |
| Repeated | Before | Pass | Pass | Pass | Pass | Pass |
| bending test 2 | After | Pass | Pass | Pass | Pass | Pass |

TABLE 6

| | | Example | Example | Example | Example | Example |
|---|---|---|---|---|---|---|
| | | 2-6 | 2-7 | 2-8 | 2-9 | 2-10 |
| Storage modulus | −20° C. | 193 | 234 | 232 | 241 | 294 |
| (MPa) | 60° C. | 49 | 60 | 61 | 65 | 65 |
| Tg (° C.) | | −57 | −52 | −49 | −53 | −49 |
| Repeated bending test 1 | | Pass | Pass | Pass | Pass | Pass |
| Repeated | Before | Pass | Pass | Pass | Pass | Pass |
| bending test 2 | After | Pass | Pass | Pass | Pass | Pass |

TABLE 7

| | | Com- | Com- | Com- | Com- |
|---|---|---|---|---|---|
| | | parative | parative | parative | parative |
| | | Example | Example | Example | Example |
| | | 2-1 | 2-2 | 2-3 | 2-4 |
| Storage modulus | −20° C. | 1,350 | 596 | 2,158 | 1,813 |
| (MPa) | 60° C. | 428 | 120 | 143 | 249 |
| Tg (° C.) | | −21 | 96 | 72 | 68 |
| Repeated bending test 1 | | Failure | Failure | Failure | Failure |
| Repeated bending | Before | Failure | Failure | Failure | Failure |
| test 2 | After | Failure | Failure | Failure | Failure |

Referring to the results of Tables 5 to 7, the films prepared from the compositions of the Examples, falling within the scope of the present invention, were overall excellent in terms of mechanical properties such as storage modulus, flexibility, pliability, glass transition temperature, and adhesion. In contrast, the films prepared from the compositions of the Comparative Examples, falling outside the scope of the present invention, were decreased in mechanical properties such as storage modulus or poor in flexibility, pliability, glass transition temperature, or adhesion, as compared with the films prepared from the compositions of the Examples.

1. A curable composition, which comprises (A) a urethane (meth)acrylate oligomer derived from a polyol represented by the following Formula 1; (B) a (meth)acrylate-based crosslinking agent; and (C) a photopolymerization initiator:
[Formula 1] [symbol]
in Formula 1, R¹ to R⁴ are each independently hydrogen or a C₁₋₆ alkyl group, a is an integer of 1 to 10, and b is an integer of 5 to 90.

2. The curable composition of claim 1, wherein the urethane (meth)acrylate oligomer (A) is derived from an acrylate-based compound, an isocyanate-based compound, and the polyol represented by the above Formula 1.

3. The curable composition of claim 2, wherein the urethane (meth)acrylate oligomer (A) is derived from 2% by weight to 10% by weight of the acrylate-based compound; 3% by weight to 20% by weight of the isocyanate-based compound; and 70% by weight to 95% by weight of the polyol represented by the above Formula 1.

4. The curable composition of claim 1, wherein the photopolymerization initiator (C) comprises a phosphine oxide-based compound or a derivative thereof.

5. The positive-type photosensitive resin composition of claim 4, wherein the photopolymerization initiator comprises diphenyl(2,4,6-trimethylbenzoyl)phosphine oxide, (2,4,6-trimethylbenzoyl)diphenylphosphine oxide, bis(2,4,6-trimethylbenzoyl)phenylphosphine oxide, phenyl bis(2,4,6-trimethylbenzoyl)phosphine oxide, or a combination thereof.

6. The curable composition of claim 1, wherein the curable composition comprises, based on solids content, the urethane (meth)acrylate oligomer (A) in an amount of 50% by weight to 90% by weight; the (meth)acrylate-based crosslinking agent (B) in an amount of 0.5% by weight to 40% by weight; and the photopolymerization initiator (C) in an amount of 0.01% by weight to 5% by weight.

7. The curable composition of claim 1, wherein the curable composition further comprises an acrylamide compound (D), and the acrylamide compound (D) comprises at least one selected from the group consisting of N,N-dimethylacrylamide, N,N-diethylacrylamide, acryloylmorpholine, N,N-isopropylacrylamide, phenylacrylamide, tert-butylacrylamide, N-methylacrylamide, and N-hydroxyethylacrylamide.

8. The curable composition of claim 7, wherein the curable composition comprises, based on solids content, the acrylamide compound (D) in an amount of 0.5% by weight to 20% by weight.

9. The curable composition of claim 1, wherein the curable composition further comprises at least one component selected from the group consisting of surfactants, toughening agents, silane coupling agents, and free radical inhibitors.

10. The curable composition of claim 9, wherein the silane coupling agent comprises an amine-based silane coupling agent represented by the following Formula 2: 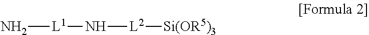
in Formula 2, L¹ and L² are each independently a C₁₋₆ alkylene group, and R⁵ is a C₁₋₆ alkyl group.

11. The curable composition of claim 9, wherein the curable composition comprises, based on solids content, the silane coupling agent in an amount of 0.01% by weight to 7% by weight.

12. A curable composition, which comprises (A) a urethane (meth)acrylate oligomer derived from a polyol represented by the following Formula 1; (B) a (meth)acrylate-based crosslinking agent; and (C) a photopolymerization initiator, wherein a film prepared from the curable composition has a glass transition temperature (Tg) of −60° C. to −10° C. when measured using a dynamic mechanical analyzer (DMA):
[Formula 1] [symbol]
in Formula 1, R¹ to R⁴ are each independently hydrogen or a C₁₋₆ alkyl group, a is an integer of 1 to 10, and b is an integer of 5 to 90.

13. A film prepared from the curable composition of claim 1.

14. The film of claim 13, which has a storage modulus at −20° ° C. of 20 MPa to 595 MPa and a storage modulus at 60° C. of 1 MPa to 350 MPa.

15. A film prepared from the curable composition of claim 12.

16. The film of claim 15, which has a storage modulus at −20° C. of 20 MPa to 595 MPa and a storage modulus at 60° C. of 1 MPa to 350 MPa.
